(19) United States
(12) Patent Application Publication
(10) Pub. No.: US 2015/0376339 A1
(43) Pub. Date: Dec. 31, 2015

(54) Process for Production of Poly(Arylene Sulfide)

(71) Applicant: SOLVAY SA, Brussels (BE)

(72) Inventors: Jeffrey S. Fodor, Bartlesville, OK (US); R. Shawn Childress, Bartlesville, OK (US); Kendall M. Hurst, Collinsville, OK (US)

(21) Appl. No.: 14/317,883

(22) Filed: Jun. 27, 2014

(51) Int. Cl. C08G 75/14

(52) U.S. Cl. CPC C08G 75/14

(57) ABSTRACT

A process comprising (a) reacting a sulfur source and a dihaloaromatic compound in the presence of a polar organic compound to form a reaction mixture, (b) quenching the reaction mixture by adding a quench liquid thereto to form a quenched mixture, wherein the quench liquid comprises a particle size modifying additive, and (c) cooling the quenched mixture to yield poly(arylene sulfide) polymer particles. A process for producing a poly(phenylene sulfide) polymer comprising (a) reacting a sulfur source and a dihaloaromatic compound in the presence of N-methyl-2-pyrrolidone to form a reaction mixture, (b) quenching the reaction mixture by adding a quench liquid thereto to form a quenched mixture, wherein the quench liquid comprises a particle size modifying additive selected from the group consisting of sodium acetate, sodium benzoate, lithium acetate, lithium benzoate, lithium formate, sodium formate, and combinations thereof, and (c) cooling the quenched mixture to yield poly(phenylene sulfide) polymer particles.

### TECHNICAL FIELD

The present disclosure relates to a process of producing polymers, more specifically poly(arylene sulfide) polymers.

### BACKGROUND

Polymers, such as poly(arylene sulfide) polymers and their derivatives, are used for the production of a wide variety of articles. The use of a particular polymer in a particular application will depend on the type of physical and/or mechanical properties displayed by the polymer (e.g., molecular weight, flow properties, etc.), and such properties are generally a result of the method used for producing a particular polymer, e.g., the reaction conditions under which the polymer is produced, the conditions under which the polymerization reaction is terminated, etc. Thus, there is an ongoing need to develop and/or improve processes for producing these polymers.

### BRIEF SUMMARY

Disclosed herein is a process comprising (a) reacting a sulfur source and a dihaloaromatic compound in the presence of a polar organic compound to form a reaction mixture, (b) quenching the reaction mixture by adding a quench liquid thereto to form a quenched mixture, wherein the quench liquid comprises a particle size modifying additive, and (c) cooling the quenched mixture to yield poly(arylene sulfide) polymer particles.

Also disclosed herein is a process for producing a poly(phenylene sulfide) polymer comprising (a) reacting a sulfur source and a dihaloaromatic compound in the presence of N-methyl-2-pyrrolidone to form a reaction mixture, (b) quenching the reaction mixture by adding a quench liquid thereto to form a quenched mixture, wherein the quench liquid comprises a particle size modifying additive selected from the group consisting of sodium acetate, sodium benzoate, lithium acetate, lithium benzoate, lithium formate, sodium formate, and combinations thereof, and (c) cooling the quenched mixture to yield poly(phenylene sulfide) polymer particles.

Further disclosed herein is a process for producing a poly(phenylene sulfide) polymer comprising (a) reacting a sulfur source and a dihaloaromatic compound in the presence of N-methyl-2-pyrrolidone to form a reaction mixture, (b) quenching the reaction mixture by adding a quench liquid thereto to form a quenched mixture, wherein the quench liquid comprises a particle size modifying additive, and (c) cooling the quenched mixture to yield poly(phenylene sulfide) polymer particles, wherein the poly(phenylene sulfide) polymer is characterized by a weight average molecular weight of less than about 40,000 g/mole, and a particle size of greater than about 80 microns.

Further disclosed herein is a process for producing a poly(phenylene sulfide) polymer via a quench process comprising adding a compound selected from the group consisting of sodium acetate, sodium benzoate, lithium acetate, lithium benzoate, sodium formate, lithium formate, and combinations thereof upon substantial completion of a reaction cycle of the quench process and prior to a cooling and particle formation cycle of the quench process.

A process for producing a poly(phenylene sulfide) polymer via a process having a reaction cycle, a quench cycle, and a cooling/particle formation cycle, wherein the process comprises adding a compound selected from the group consisting of sodium acetate, sodium benzoate, lithium acetate, lithium benzoate, sodium formate, lithium formate, and combinations thereof during the quench cycle.

Further disclosed herein is a process for producing a poly(phenylene sulfide) polymer comprising (a) polymerizing reactants in a reaction vessel, wherein at least a portion of the reactants undergo a polymerization reaction, (b) quenching the polymerization reaction by adding a quench liquid to the reaction vessel, wherein the quench liquid comprises a particle size modifying additive, and (c) cooling down the reaction vessel, thereby forming raw poly(phenylene sulfide) polymer particles.

Further disclosed herein is a process for producing a poly(phenylene sulfide) polymer comprising (a) polymerizing reactants in a reaction vessel, wherein at least a portion of the reactants undergo a polymerization reaction, (b) quenching the polymerization reaction by adding a quench liquid to the reaction vessel, wherein the quench liquid comprises a particle size modifying additive selected from the group consisting of sodium acetate, sodium benzoate, lithium acetate, lithium benzoate, sodium formate, lithium formate, and combinations thereof, and (c) cooling down the reaction vessel, thereby forming raw poly(phenylene sulfide) polymer particles, wherein the poly(phenylene sulfide) polymer is characterized by a weight average molecular weight of less than about 40,000 g/mole, and wherein the raw poly(phenylene sulfide) polymer particles are characterized by a particle size of greater than about 80 microns.

### DETAILED DESCRIPTION

Disclosed herein are processes for producing poly(arylene sulfide) polymers. The present application relates to poly(arylene sulfide) polymers, also referred to herein simply as “poly(arylene sulfide).” In the various embodiments disclosed herein, it is to be expressly understood that reference to poly(arylene sulfide) polymer specifically includes, without limitation, polyphenylene sulfide polymer (or simply, polyphenylene sulfide), also referred to as PPS polymer (or simply, PPS).

In an embodiment, a process for producing a poly(arylene sulfide) polymer can comprise the steps of (a) reacting a sulfur source and a halogenated aromatic compound having two halogens (e.g., dihaloaromatic compound) in the presence of a polar organic compound to form a reaction mixture; (b) quenching the reaction mixture by adding a quench liquid thereto to form a quenched mixture, wherein the quench liquid comprises a particle size modifying additive; and (c) cooling the quenched mixture to yield poly(arylene sulfide) polymer particles. In an alternative embodiment, a process for producing a poly(arylene sulfide) polymer can comprise the steps of (a) polymerizing reactants in a reaction vessel, wherein at least a portion of the reactants undergo a polymerization reaction; (b) quenching the polymerization reaction by adding a quench liquid to the reaction vessel, wherein the quench liquid comprises a particle size modifying additive; and (c) cooling down the reaction vessel, thereby forming poly(arylene sulfide) polymer particles. In various embodiments, the process can further comprise one or more additional steps, for example at least one step selected from the group consisting of: (d) separating the poly(arylene sulfide) polymer particles from the quenched mixture to obtain poly(arylene sulfide) polymer particles; (e) treating at least a portion of the poly(arylene sulfide) polymer particles with an aqueous acid solution and/or an aqueous metal cation solution to obtain a treated poly(arylene sulfide) polymer, wherein the treated poly(arylene sulfide) polymer is recovered from a treatment solution via a separation (e.g., filtration) step; (f) drying at least a portion of the poly(arylene sulfide) polymer particles to obtain a dried poly(arylene sulfide) polymer; (g) curing at least a portion of the poly(arylene sulfide) polymer particles to obtain a cured poly(arylene sulfide) polymer; and any combination thereof. In an embodiment, the poly(arylene sulfide) polymer can be characterized by a weight average molecular weight of less than about 40,000 g/mole and/or a particle size of greater than about 80 microns.

In an embodiment, the particle size modifying additive can be added to the reaction mixture (e.g., to the reaction vessel) in an amount effective to increase a yield of the poly(arylene sulfide) polymer by greater than about 5 wt. %, when compared to adding an otherwise similar quench liquid lacking the particle size modifying additive. In an embodiment, the particle size modifying additive can be added to the reaction mixture (e.g., to the reaction vessel) in an amount effective to increase a particle size of the poly(arylene sulfide) polymer particles by greater than about 10%, when compared to adding an otherwise similar quench liquid lacking the particle size modifying additive. In an embodiment, a process of the present disclosure comprises adding a particle size modifying additive to a reaction mixture (e.g., to a reaction vessel) in an amount effective to increase the yield of the poly(arylene sulfide) polymer. While the present disclosure will be discussed in detail in the context of a process for producing a poly(arylene sulfide) polymer, it should be understood that such process or any steps thereof can be applied in a process for producing any other suitable polymer. The polymer can comprise any polymer compatible with the disclosed methods and materials.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed. (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogen atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

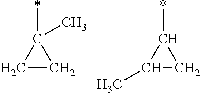

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

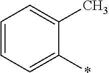 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a —(Ar—S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise units having one or more of the following structures, wherein (*) as used throughout the disclosure represents a continuing portion of a polymer chain or terminal group:

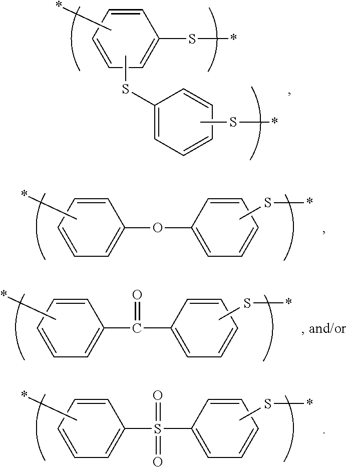

In an embodiment, the arylene sulfide unit can be represented by Formula I.

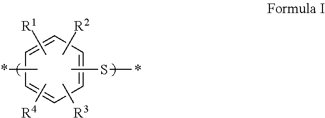

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the —(Ar—S)— unit. Other suitable ranges for the para-phenylene sulfide units will be readily apparent to one of skill in the art with the help of this disclosure. The structure for the para-phenylene sulfide unit can be represented by Formula II.

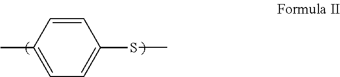

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfone groups, or groups having the following structures:

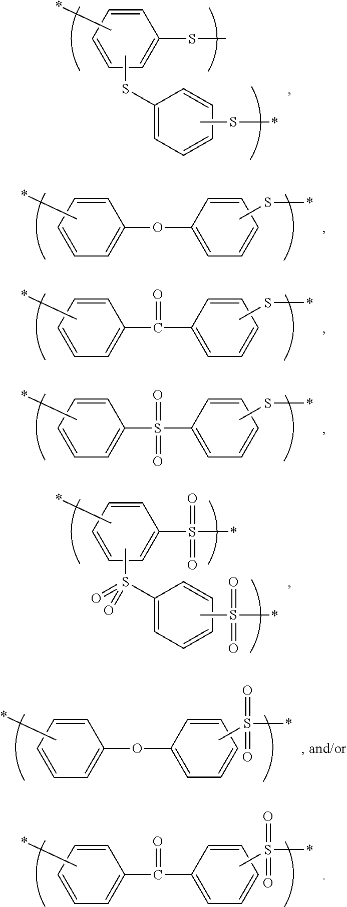

In other embodiments, PPS can comprise up to about 30, 20, 10, or 5 mole percent of units having one or more of the following structures:

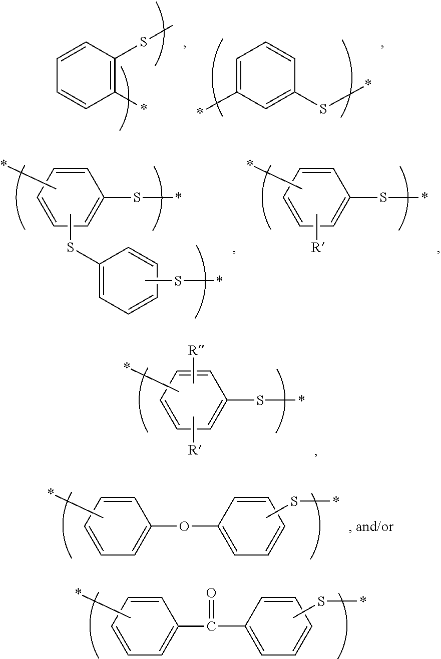

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

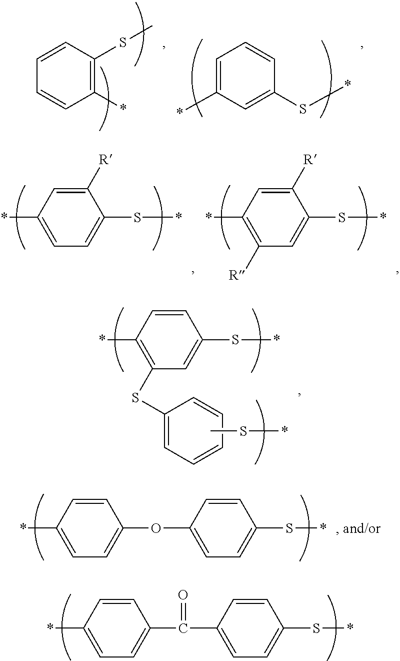

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

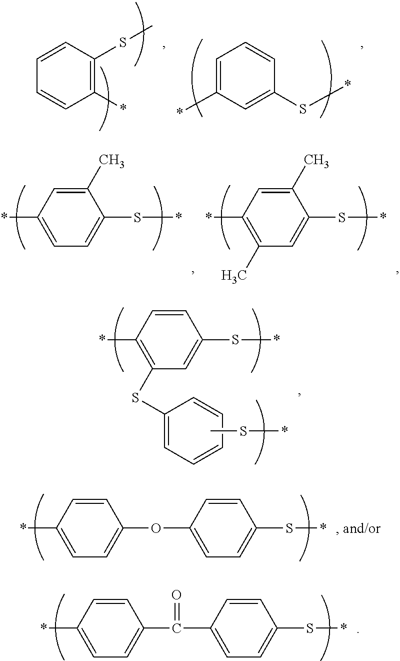

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS cannot typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

In an embodiment, the process for producing a poly(arylene sulfide) polymer can comprise a quench process. In such embodiment, the quench process can comprise a reaction or polymerization cycle, a quench cycle, and a cooling and particle formation cycle (e.g., cooling/particle formation cycle).

In an embodiment, the reaction cycle of the quench process (e.g., a polymerization reaction) comprises reacting a sulfur source and a halogenated aromatic compound having two halogens (e.g., dihaloaromatic compound) in the presence of a polar organic compound to form a reaction mixture (e.g., a polymerization reaction mixture).

In an embodiment, the process for producing a poly(arylene sulfide) polymer comprises reacting a sulfur source and a halogenated aromatic compound having two halogens (e.g., dihaloaromatic compound) in the presence of a polar organic compound to form a reaction mixture (e.g., a poly(arylene sulfide) reaction mixture). In an embodiment, the process for producing a poly(arylene sulfide) polymer comprises polymerizing reactants (e.g., a sulfur source and a dihaloaromatic compound) in a reaction vessel or reactor, to produce a reaction mixture (e.g., a poly(arylene sulfide) reaction mixture), wherein at least a portion of the reactants undergo a polymerization reaction.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a polyhalo-substituted aromatic compound, such as for example a halogenated aromatic compound having greater than two halogen atoms (e.g., 1,2,4-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens (e.g., dihaloaromatic compounds) which can be employed to produce the poly(arylene sulfide) can be represented by Formula III.

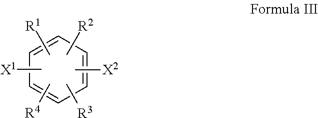

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³ and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichlorobenzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

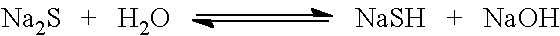

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

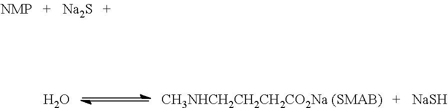

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, the reactants can further comprise a molecular weight modifying agent. In an embodiment, a reaction mixture for preparation of a poly(arylene sulfide) (e.g., a poly(arylene sulfide) reaction mixture) can further comprise a molecular weight modifying agent, such as for example an alkali metal carboxylate.

Alkali metal carboxylates which can be employed as molecular weight modifying agents include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution, slurry and/or dispersion in water and/or polar organic compound.

Nonlimiting examples of alkali metal carboxylates suitable for use in the present disclosure as molecular weight modifying agents include sodium acetate, sodium benzoate, lithium acetate, lithium benzoate, lithium formate, sodium formate, and combinations thereof. In an embodiment, the alkali metal carboxylate can be, comprise, or consist essentially of, sodium acetate (NaOAc or NaC₂H₃O₂).

Generally, the ratio of reactants employed in the polymerization process to produce a poly(arylene sulfide) can vary widely. However, the typical equivalent molar ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound (e.g., trihaloaromatic compound) optionally employed as a reactant can be any amount to achieve a desired degree of branching to give a desired poly(arylene sulfide) melt flow. Generally, up to about 0.02 mole of polyhalo-substituted aromatic compound per mole of halogenated aromatic compound having two halogens can be employed. As will be appreciated by one of skill in the art, and with the help of this disclosure, generally, the flow properties of a polymer (e.g., melt flow, flow rate, etc.) correlate with the degree of branching (e.g., the use of a polyhalo-substituted aromatic compound could cause branching and lower the flow rate). If an alkali metal carboxylate is employed as a molecular weight modifying agent, the mole ratio of alkali metal carboxylate to dihaloaromatic compound(s) can be within the range of from about 0 to about 2; alternatively, from about 0.01 to about 2; alternatively, from about 0.05 to about 1; or alternatively, from about 0.1 to about 2.

In an embodiment, the molecular weight modifying agent can be present in the reaction mixture in an amount of from about 0 mole to about 1.0 mole of molecular weight modifying agent per mole of sulfur, alternatively from about 0.01 mole to about 1.0 mole of molecular weight modifying agent per mole of sulfur, or alternatively from about 0.1 mole to about 0.8 mole of molecular weight modifying agent per mole of sulfur.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure. As will be appreciated by one of skill in the art and with the help of this disclosure, a “termination process” refers to a process by which a polymerization reaction (e.g., a polymerization reaction yielding a poly(arylene sulfide) polymer) is terminated (e.g., stopped, ceased, finished, concluded, ended, completed, finalized, etc.). Further, as will be appreciated by one of skill in the art and with the help of this disclosure, a polymerization reaction can be considered “terminated” when polymerization is substantially complete or when further reaction would not result in a significant increase in polymer molecular weight.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 mole of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure can be in the range of from about 0 psig to about 400 psig; alternatively, in the range of from about 30 psig to about 300 psig; or alternatively, in the range of from about 100 psig to about 250 psig.

The polymerization can be terminated (e.g., quenched) by cooling the reaction mixture (removing heat) to a temperature below that at which substantial polymerization takes place. In some instances the cooling of the reaction mixture can also begin the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

The poly(arylene sulfide) reaction mixture can be quenched using a variety of methods. In an embodiment, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid (e.g., a quench liquid) comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) reaction mixture. In yet other embodiments, the polymerization can be terminated by adding a solvent(s) other than water or the polar organic compound to the poly(arylene sulfide) reaction mixture and cooling the poly(arylene sulfide) reaction mixture. Processes for preparing poly(arylene sulfide) which utilize the addition of water, polar organic compound, and/or other solvent(s) to terminate the reaction can be referred to as a quench termination process. The cooling of the reaction mixture can be facilitated by the use of reactor jackets or coils. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

In an embodiment, the process for producing a poly(arylene sulfide) polymer is a quench process comprising a quench cycle, wherein the quench cycle comprises the step of quenching the reaction mixture (e.g., step of quenching the polymerization reaction) with a quench liquid, wherein the quench liquid can comprise a particle size modifying additive.

In an embodiment, the process for producing a poly(arylene sulfide) polymer can comprise a step of quenching the reaction mixture by adding a quench liquid thereto to form a quenched mixture. In such embodiment, the quench liquid can comprise a particle size modifying additive. In an embodiment, the process for producing a poly(arylene sulfide) polymer can comprise a step of quenching the polymerization reaction by adding a quench liquid to the reaction mixture (e.g., to the reaction vessel), wherein the quench liquid can comprise a particle size modifying additive. As will be appreciated by one of skill in the art and with the help of this disclosure, the reaction cycle ends or the quench cycle begins when polymerization is substantially complete or when further reaction would not result in a significant increase in polymer molecular weight. Further, as will be appreciated by one of skill in the art and with the help of this disclosure, the timing for ending the reaction cycle or beginning the quench cycle can be determined by monitoring process parameters such as for example time, temperature, and/or pressure.

In an embodiment, the quench liquid can comprise water, a polar organic compound, or combinations thereof.

In an embodiment, the particle size modifying additive comprises an alkali metal carboxylate. As will be appreciated by one of skill in the art, and with the help of this disclosure, the alkali metal carboxylates described as molecular weight modifying agents can also be used as particle size modifying additives. In some embodiments, when a molecular weight modifying agent is employed, the molecular weight modifying agent and the particle size modifying additive can be the same (e.g., the same compound). For example, the molecular weight modifying agent and the particle size modifying additive can both be sodium acetate. In other embodiments, when a molecular weight modifying agent is employed, the molecular weight modifying agent and the particle size modifying additive can be the different from each other (e.g., different compounds). For example, the molecular weight modifying agent can be a lithium halide and the particle size modifying additive can be sodium acetate.

In an embodiment, the particle size modifying additive comprises an alkali metal carboxylate having a general formula R′CO₂M, wherein R′ can be a C₁ to C₂₀ hydrocarbyl group, alternatively a C₁ to C₂₀ hydrocarbyl group, or alternatively a C₁ to C₅ hydrocarbyl group. In some embodiments, R′ can be an alkyl group, a cycloalkyl group, an aryl group, aralkyl group; or alternatively, an alkyl group, as disclosed herein for the alkali metal carboxylate employed as a molecular weight modifying agent. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium.

Nonlimiting examples of alkali metal carboxylate suitable for use in the present disclosure as particle size modifying additives include sodium acetate, sodium benzoate, lithium acetate, lithium benzoate, lithium formate, sodium formate, and combinations thereof.

In an embodiment, the quench liquid comprises water and/or a polar organic compound. In such embodiment, the particle size modifying additive can be added to the reaction mixture (e.g., to the reaction vessel) as a solution, slurry and/or dispersion in the quench liquid. In some embodiments, the particle size modifying additive can be added to the reaction mixture (e.g., to the reaction vessel) as a solid (e.g., powder, crystals, hydrates, etc.).

In an embodiment, adding a quench liquid comprising water to the reaction mixture (e.g., to the reaction vessel) can cause at least a portion of the poly(arylene sulfide) polymer to precipitate from solution (e.g., reaction mixture, poly(arylene sulfide) reaction mixture), thereby forming a particulate poly(arylene sulfide) (e.g., poly(arylene sulfide) polymer particles). Without wishing to be limited by theory, the poly(arylene sulfide) polymer is more soluble in the polar organic compound than in water, and introducing water into the reaction vessel can cause at least a portion of the poly(arylene sulfide) polymer to precipitate, in part due to the polar organic compound being at least partially miscible with the water.

In an embodiment, the particle size modifying additive can be included within the quench liquid in a suitable or effective amount, e.g., an amount effective to increase the yield of the poly(arylene sulfide) polymer. As will be appreciated by one of skill in the art, and with the help of this disclosure, the particle size modifying additive can increase the yield of the poly(arylene sulfide) polymer by increasing a particle size of poly(arylene sulfide) polymer particles, thereby causing the poly(arylene sulfide) polymer particles to be more easily retained/recovered on screens that can be used during the recovery and/or processing of the poly(arylene sulfide) polymer. The resultant concentration and/or amount of the particle size modifying additive that is necessary to increase the yield of the poly(arylene sulfide) polymer can be dependent upon a variety of factors such as the composition of the quench liquid; the amount of molecular weight modifying agent used; the amount of water present in the reaction vessel at the time when the particle size modifying additive is added to the reaction vessel; or combinations thereof.

In an embodiment, the particle size modifying additive can be added to the reaction mixture (e.g., to the reaction vessel) in an amount effective to increase a yield of the poly(arylene sulfide) polymer by greater than about 5 wt. %, alternatively by greater than about 10 wt. %, alternatively by greater than about 25 wt. %, or alternatively by greater than about 50 wt. %, when compared to adding to the reaction mixture (e.g., to the reaction vessel) an otherwise similar quench liquid lacking the particle size modifying additive.

In an embodiment, the particle size modifying additive can be added to the reaction mixture (e.g., to the reaction vessel) in an amount effective to increase the particle size of the poly(arylene sulfide) polymer particles by greater than about 10%, alternatively by greater than about 25%, or alternatively by greater than about 50%, when compared to adding to the reaction mixture (e.g., to the reaction vessel) an otherwise similar quench liquid lacking the particle size modifying additive.

In an embodiment, the particle size modifying additive can be added to the reaction mixture (e.g., to the reaction vessel) in an amount of from about 0.01 mole to about 1.0 mole of particle size modifying additive per mole of sulfur, alternatively from about 0.05 mole to about 0.75 mole of particle size modifying additive per mole of sulfur, or alternatively from about 0.1 mole to about 0.5 mole of particle size modifying additive per mole of sulfur.

In an embodiment, the particle size modifying additive can be present in the quench liquid in an amount of from about 1 wt. % to about 80 wt. %, alternatively from about 5 wt. % to about 75 wt. %, or alternatively from about 10 wt. % to about 50 wt. %, based on the total weight of the quench liquid.

In some embodiments, when a molecular weight modifying agent is employed, the molecular weight modifying agent and the particle size modifying additive can be added to the reaction mixture (e.g., to the reaction vessel) in a mole ratio of from about 0.00:0.01 to about 1:0.01 of molecular weight modifying agent to particle size modifying additive, alternatively from about 0.01:0.01 to about 1:0.1, or alternatively from about 0.01:0.05 to about 0.01:0.1.

In some embodiments, when a molecular weight modifying agent is employed, the amount of the molecular weight modifying agent added in the step of reacting a sulfur source and a dihaloaromatic compound, and the amount of particle size modifying additive added in the step of quenching the reaction mixture total from about 0.01 mole to about 1 mole of molecular weight modifying agent and particle size modifying additive per mole of sulfur, alternatively from about 0.05 mole to about 0.75 mole of molecular weight modifying agent and particle size modifying additive per mole of sulfur, or alternatively from about 0.1 mole to about 0.5 mole of molecular weight modifying agent and particle size modifying additive per mole of sulfur.

In an embodiment, adding a quench liquid comprising the particle size modifying additive to a reaction mixture (e.g., to a reaction vessel) can decrease a reaction pressure (e.g., a pressure in the reactor vessel) by from about 1% to about 30%, alternatively by from about 5% to about 25%, or alternatively by from about 10% to about 20%, when compared to adding to the reaction mixture (e.g., to the reaction vessel) an otherwise similar quench liquid lacking the particle size modifying additive. Without wishing to be limited by theory, the presence of the particle size modifying additive in the quench liquid can contribute to an overall boiling point elevation (e.g., an increase in the boiling point of the reaction mixture and/or the quenched mixture), thereby causing the poly(arylene sulfide) reaction mixture to boil at a higher temperature. As will be appreciated by one of skill in the art, and with the help of this disclosure, when a quench liquid comprising water is added to the reaction mixture (e.g., to the reaction vessel), a rise in pressure (e.g., reaction pressure) can be observed due to the evaporation of water inside the reaction vessel. Further, without wishing to be limited by theory, when the overall boiling point of the poly(arylene sulfide) reaction mixture (e.g., quenched mixture) is elevated due to the presence of the particle size modifying additive, less water will evaporate, thereby causing a lower pressure (e.g., reaction pressure) increase inside the reaction vessel than in the case when the quench liquid does not comprise a particle size modifying additive.

In an embodiment, the cooling and particle formation cycle of the quench process can comprise the step of cooling the quenched mixture to yield poly(arylene sulfide) polymer particles (e.g., step of cooling the reaction vessel containing the reaction mixture and/or the quenched mixture).

In an embodiment, the process for producing a poly(arylene sulfide) polymer can comprise a step of cooling the quenched mixture to yield poly(arylene sulfide) polymer particles. In an embodiment, the process for producing a poly(arylene sulfide) polymer can comprise a step of cooling the reaction vessel containing the reaction mixture and/or the quenched mixture, thereby forming poly(arylene sulfide) polymer particles. In an embodiment, the step of cooling the reaction vessel containing the quenched mixture and/or the reaction mixture can begin prior to, concurrent with, and/or subsequent to the step of quenching the reaction mixture (e.g., quenching the polymerization reaction). In an embodiment, cooling the quenched mixture (e.g., cooling the reaction vessel containing the quenched mixture and/or the reaction mixture) can be a ramped cooling process, wherein the temperature is decreased or lowered in a controlled fashion over time.

In an embodiment, cooling the quenched mixture (e.g., cooling the reaction vessel containing the quenched mixture and/or the reaction mixture) can comprise the use of external cooling; jacket cooling; internal cooling; adding a liquid (e.g., quench liquid) to the reaction vessel, wherein the temperature of the quench liquid is lower than the temperature of the reaction mixture (e.g., the temperature inside the reaction vessel); and the like; or combinations thereof.

In an embodiment, cooling the quenched mixture (e.g., cooling the reaction vessel containing the quenched mixture and/or the reaction mixture) can cause at least a portion of the poly(arylene sulfide) polymer to precipitate from solution (e.g., quenched mixture), thereby forming a particulate poly(arylene sulfide) (e.g., poly(arylene sulfide) polymer particles). As will be appreciated by one of skill in the art, and with the help of this disclosure, the lower the temperature (e.g., a temperature of the quenched mixture, a temperature inside the reaction vessel), the less soluble the poly(arylene sulfide) polymer.

In an embodiment, the poly(arylene sulfide) polymer can be a low molecular weight poly(arylene sulfide) polymer. In an embodiment, the poly(arylene sulfide) polymer can be characterized by an weight average molecular weight (M_{w}) of less than about 40,000 g/mole, alternatively less than about 30,000 g/mole, alternatively less than about 20,000 g/mole, alternatively from about 20,000 g/mole to about 40,000 g/mole, alternatively from about 20,000 g/mole to about 30,000 g/mole, alternatively from about 30,000 g/mole to about 40,000 g/mole, or alternatively from about 30,000 g/mole to about 35,000 g/mole; a number average molecular weight (Mₙ) of less than about 20,000 g/mole, alternatively less than about 15,000 g/mole, alternatively less than about 10,000 g/mole, alternatively from about 5,000 g/mole to about 20,000 g/mole, alternatively from about 10,000 g/mole to about 15,000 g/mole, or alternatively from about 5,000 g/mole to about 12,000 g/mole; and a z-average molecular weight (Mₜ) of less than about 55,000 g/mole, alternatively less than about 50,000 g/mole, alternatively less than about 45,000 g/mole, alternatively from about 30,000 g/mole to about 55,000 g/mole, alternatively from about 35,000 g/mole to about 55,000 g/mole, or alternatively from about 40,000 g/mole to about 55,000 g/mole. The weight average molecular weight describes the size average of a polymer composition and can be calculated according to equation 1:

$${M}_{w} = \frac{{\sum }_{i} {N}_{i} {M}_{i}^{2}}{{\sum }_{i} {N}_{i} {M}_{i}} \qquad ( 1 )$$

wherein Nᵢ is the number of molecules of molecular weight Mᵢ. All molecular weight averages are expressed in gram per mole (g/mole) or Daltons (Da). The number average molecular weight is the common average of the molecular weights of the individual polymers calculated by measuring the molecular weight Mᵢ of Nᵢ polymer molecules, summing the weights, and dividing by the total number of polymer molecules, according to equation 2:

$${M}_{n} = \frac{{\sum }_{i} {N}_{i} {M}_{i}}{{\sum }_{i} {N}_{i}} \qquad ( 2 )$$

The z-average molecular weight is a higher order molecular weight average which is calculated according to equation 3:

$${M}_{z} = \frac{{\sum }_{i} {N}_{i} {M}_{i}^{3}}{{\sum }_{i} {N}_{i} {M}_{i}^{2}} \qquad ( 3 )$$

wherein Nᵢ is the number of molecules of molecular weight Mᵢ.

In an embodiment, the poly(arylene sulfide) polymer can be characterized by a peak molecular weight (Mₚ) of less than about 45,000 g/mole, alternatively less than about 35,000 g/mole, alternatively less than about 25,000 g/mole, alternatively from about 20,000 g/mole to about 45,000 g/mole, alternatively from about 25,000 g/mole to about 40,000 g/mole, or alternatively from about 30,000 g/mole to about 35,000 g/mole. The peak molecular weight is defined as the molecular weight of the highest peak, wherein the molecular weight is measured by size exclusion chromatography (SEC) or a similar method.

In an embodiment, the particle size modifying additive does not modify (e.g., alter, change, increase, decrease, etc.) the molecular weight of the poly(arylene sulfide) polymer (e.g., the weight average molecular weight of the poly(arylene sulfide) polymer). As will be appreciated by one of skill in the art, and with the help of this disclosure, the particle size modifying additive is added to the reaction mixture (e.g., to the reaction vessel) at the end of the polymerization reaction, i.e., after the polymer has already formed. Further, as will be appreciated by one of skill in the art, and with the help of this disclosure, while some compounds (e.g., alkali metal carboxylate) can be used both as a particle size modifying additive and a molecular weight modifying agent, the specific step in the polymerization process when such compounds are added will determine whether the compound will function as a particle size modifying additive and/or as a molecular weight modifying agent. For example, if an alkali metal carboxylate is added to the reaction mixture (e.g., to the reaction vessel) during the step of quenching the reaction mixture (e.g., quenching the polymerization reaction), such alkali metal carboxylate can function as a particle size modifying additive, and it may not modify the molecular weight (e.g., weight average molecular weight) of the poly(arylene sulfide) polymer, e.g., it will not function as a molecular weight modifying agent. As another example, if an alkali metal carboxylate is added to the reaction mixture (e.g., to the reaction vessel) during the step of reacting a sulfur source and a dihaloaromatic compound (e.g., polymerizing reactants), such alkali metal carboxylate can function as a molecular weight modifying agent and can modify the molecular weight (e.g., weight average molecular weight) of the poly(arylene sulfide) polymer (e.g., can increase the molecular weight of the poly(arylene sulfide) polymer). As will be appreciated by one of skill in the art, and with the help of this disclosure, at least a portion of the alkali metal carboxylate added as a molecular weight modifying agent during the step of reacting a sulfur source and a dihaloaromatic compound (e.g., polymerizing reactants) can still be present in the reaction mixture (e.g., the reaction vessel containing the reaction mixture) during the step of quenching the reaction mixture (e.g., quenching the polymerization reaction), and consequently can function as a particle size modifying additive. However, when a goal of the polymerization process is to obtain a low molecular weight polymer, the amount of alkali metal carboxylate that can be added during the step of reacting a sulfur source and a dihaloaromatic compound (e.g., polymerizing reactants) is limited, as the alkali metal carboxylates can increase the molecular weight (e.g., weight average molecular weight) of the polymer above a desired value. In such instances, more alkali metal carboxylate can be added during the step of quenching the reaction mixture (e.g., quenching the polymerization reaction), such that the reaction mixture can contain an amount of particle size modifying additive (e.g., alkali metal carboxylate) effective to obtain the desired polymer yield and/or polymer particle size in combination with a desired molecular weight (e.g., weight average molecular weight) of the polymer (e.g., less than about 40,000 g/mole, less than about 30,000 g/mole, less than about 20,000 g/mole, etc.).

Once the poly(arylene sulfide) polymer has precipitated from solution, a particulate poly(arylene sulfide) (e.g., poly(arylene sulfide) polymer particles) can be separated (e.g., recovered, retrieved, obtained, etc.) from the poly(arylene sulfide) reaction mixture (e.g., poly(arylene sulfide) reaction mixture slurry) by any process capable of separating a solid precipitate from a liquid. For purposes of the disclosure herein, the particulate poly(arylene sulfide) separated from the poly(arylene sulfide) reaction mixture will be referred to as “poly(arylene sulfide) polymer particles,” “poly(arylene sulfide) particles,” “particulate poly(arylene sulfide) polymer,” or “particulate poly(arylene sulfide).” For purposes of the disclosure herein, poly(arylene sulfide) polymer particles can also be referred to as “raw particulate poly(arylene sulfide) polymer,” “raw particulate poly(arylene sulfide),” “raw poly(arylene sulfide) polymer particles,” “raw poly(arylene sulfide) particles,” “raw poly(arylene sulfide) polymer,” or simply “raw poly(arylene sulfide),” (e.g., “raw PPS”) where further processing steps are contemplated after separation of the polymer particles from the poly(arylene sulfide) reaction mixture.

It should be noted that the process to produce the poly(arylene sulfide) can form a by-product alkali metal halide. The by-product alkali metal halide can be removed during process steps utilized to separate the poly(arylene sulfide) polymer particles. Procedures which can be utilized to separate the poly(arylene sulfide) polymer particles from the reaction mixture slurry can include, but are not limited to, i) filtration, ii) washing the poly(arylene sulfide) polymer particles with a liquid (e.g., water or aqueous solution), or iii) dilution of the reaction mixture with liquid (e.g., water or aqueous solution) followed by filtration and washing the poly(arylene sulfide) polymer particles with a liquid (e.g., water or aqueous solution). For example, in a non-limiting embodiment, the reaction mixture slurry can be filtered to separate the poly(arylene sulfide) polymer particles (containing poly(arylene sulfide) or PPS, and by-product alkali metal halide), which can be slurried in a liquid (e.g., water or aqueous solution) and subsequently filtered to remove the alkali metal halide by-product (and/or other liquid, e.g., water, soluble impurities). Generally, the steps of slurrying the poly(arylene sulfide) polymer particles with a liquid followed by filtration to separate the poly(arylene sulfide) polymer particles can occur as many times as necessary to obtain a desired level of purity of the poly(arylene sulfide) polymer.

In an embodiment, the poly(arylene sulfide) polymer particles can be separated from the poly(arylene sulfide) reaction mixture by way of a screening process, e.g., passing the poly(arylene sulfide) reaction mixture through a screen (e.g., sieve, mesh, wire screen, wire sieve, wire mesh, etc.), wherein the poly(arylene sulfide) polymer particles are retained on the screen. In such embodiment, a polymer particle size can be determined with reference to a screen size, typically in conjunction with a separation process (e.g., separating the poly(arylene sulfide) polymer particles from the quenched mixture via a screening process having one or more screens as described herein to obtain poly(arylene sulfide) polymer particles). In an alternative embodiment, a polymer particle size can be determined with respect to a poly(arylene sulfide) polymer at any point during the quench process, polymerization process, separation process, processing, treatment, etc.

In an embodiment, the poly(arylene sulfide) polymer particles can be characterized by a poly(arylene sulfide) polymer particle size (e.g., particle size). As used herein, particle size is determined in accordance with the ability of a polymer particle (e.g., poly(arylene sulfide) polymer particle) to pass through a woven wire test sieve as described in ASTM E11-09. For purposes of this disclosure, all references to a woven wire test sieve refer to a woven wire test sieve as described in ASTM E11-09. As used herein, reference to particle size refers to the size of an aperture (e.g., nominal aperture dimension) through which the polymer particle (e.g., poly(arylene sulfide) polymer particle) will pass, and for brevity this is referred to herein as “particle size.” An aperture is an opening in a sieve (e.g., woven wire test sieve) or a screen for particles to pass through. The aperture of the woven wire test sieve is a square and the nominal aperture dimension refers to the width of the square aperture. For purposes of this disclosure, all references to the ability of a polymer particle to pass through a woven wire test sieve refer to the ability of a polymer particle to pass through a woven wire test sieve as measured in accordance with ASTM D1921-12. As will be appreciated by one of skill in the art, and with the help of this disclosure, the particle size can be determined by wet testing, e.g., the ability of a polymer particle to pass through a woven wire test sieve can be measured by passing an amount of a slurry (e.g., reaction mixture slurry, quenched mixture slurry) containing the polymer particles through a woven wire test sieve. For example, a polymer particle is considered to have a size of less than about 500 microns if the polymer particle passes through the aperture of a 35 mesh woven wire test sieve, where the mesh size is given based on U.S. Sieve Series. Similarly, a polymer particle is considered to have a size of greater than about 500 microns if the polymer particle does not pass through the aperture of a 35 mesh woven wire test sieve, where the mesh size is given based on U.S. Sieve Series. As will be appreciated by one of skill in the art, and with the help of this disclosure, polymer particles can have a plurality of shapes, such as for example cylindrical, discoidal, spherical, tabular, ellipsoidal, equant, irregular, or combinations thereof. Generally, for a polymer particle to pass through an aperture of a sieve or screen, it is not necessary for all dimensions of the particle to be smaller than the aperture of such screen or sieve, and it could be enough for one of the dimensions of the polymer particle to be smaller than the aperture of such screen or sieve. For example, if a cylindrical shaped polymer particle that has a diameter of 300 microns and a length of 800 microns passes through the aperture of a 35 mesh woven wire test sieve, where the mesh size is according to U.S. Sieve Series, such polymer particle is considered to have a particle size of less than about 500 microns. Further, for example, if a cylindrical shaped polymer particle that has a diameter of 500 microns and a length of 700 microns does not pass through the aperture of a 35 mesh woven wire test sieve, where the mesh size is according to U.S. Sieve Series, such polymer particle is considered to have a particle size of greater than about 500 microns.

In an embodiment, the poly(arylene sulfide) polymer particles can be characterized by the particle size of greater than about 80 microns, alternatively greater than about 150 microns, or alternatively greater than about 200 microns.

In an embodiment, the poly(arylene sulfide) polymer particles comprise a plurality of particle sizes, e.g., the polymer particle size is non-uniform across a sample (e.g., a portion) of poly(arylene sulfide) polymer particles. In such embodiment, the poly(arylene sulfide) polymer particles can be characterized with reference to the amount of material that will pass through a particular sieve (e.g., woven wire test sieve) when measured in accordance with ASTM D1921-12, e.g., Dw10, Dw50, Dw90, etc. The Dw50 refers to 50 wt. % of the total poly(arylene sulfide) polymer particle population having sizes at or below an indicated value, while the other 50 wt. % of the total poly(arylene sulfide) polymer particle population has sizes above the indicated value. The Dw10 and Dw90 refer to the cumulative undersize distribution which notes the percentage weight of poly(arylene sulfide) polymer particles (i.e., 10 wt. % or 90 wt. %) having sizes at or below the indicated value. The Dw10, Dw50, Dw90 can be determined by standard particle size measurements, such as physically sifting (e.g., wet sifting) the material (e.g., sifting through a woven wire test sieve) in accordance with ASTM D1921-12 and measuring the mass of each fraction and calculating that fraction as a percentage of the total. For example, if 90 wt. % of the poly(arylene sulfide) polymer particles have a particle size of less than about 500 microns, and 10 wt. % of the poly(arylene sulfide) polymer particles have a particle size of equal to or greater than about 500 microns, then the poly(arylene sulfide) polymer particles have a Dw90 of less than about 500 microns. As will be appreciated by one of skill in the art, and with the help of this disclosure, it is not necessary to sift/test the entire amount of poly(arylene sulfide) polymer particles for determining the particle size distribution; it is usually sufficient to use at least one representative sample of the poly(arylene sulfide) polymer particles, such as for example a sample of the poly(arylene sulfide) polymer particles that has about the same particle size distribution as the entire amount of poly(arylene sulfide) polymer particles.

In an embodiment, the poly(arylene sulfide) polymer particles have a particle size distribution wherein the Dw90 is equal to or greater than about 100 microns, alternatively equal to or greater than about 200 microns, or alternatively equal to or greater than about 300 microns.

In an embodiment, the poly(arylene sulfide) polymer particles have a particle size distribution wherein Dw10 is equal to or greater than about 80 microns, alternatively, Dw50 is equal to or greater than about 90 microns, or alternatively, Dw90 is equal to or greater than about 100 microns.

In an embodiment, the poly(arylene sulfide) polymer particles have a particle size that is characterized by equal to or greater than about 95 wt. % of the polymer particles being retained on a 100 mesh sieve, alternatively, greater than about 98 wt. %, or alternatively, about 100 wt. %. In an embodiment, the poly(arylene sulfide) polymer particles have a particle size that is characterized by equal to or greater than about 95 wt. % of the polymer particles being retained on a 70 mesh sieve, alternatively, greater than about 98 wt. %, or alternatively, about 100 wt. %. In an embodiment, the poly(arylene sulfide) polymer particles have a particle size that is characterized by equal to or greater than about 95 wt. % of the particles being retained on a 50 mesh sieve, alternatively, greater than about 98 wt. %, or alternatively, about 100 wt. %.

In an embodiment, a process for producing a poly(arylene sulfide) polymer can optionally comprise a step of treating at least a portion of the poly(arylene sulfide) polymer (e.g., poly(arylene sulfide) polymer particles) with an aqueous acid solution and/or an aqueous metal cation solution to obtain a treated poly(arylene sulfide) polymer, wherein the treated poly(arylene sulfide) polymer can be recovered from a treatment solution via a separation (e.g., filtration) step.

In an embodiment, the poly(arylene sulfide) polymer can be treated with an aqueous acid solution and/or can be treated with an aqueous metal cation solution, to yield treated poly(arylene sulfide) (e.g., acid treated poly(arylene sulfide) and/or metal cation treated poly(arylene sulfide)). Additionally, the poly(arylene sulfide) polymer can be dried to remove liquid adhering to the poly(arylene sulfide) polymer particles. Generally, the poly(arylene sulfide) polymer which can be treated can be i) the poly(arylene sulfide) polymer particles separated from the reaction mixture or ii) the poly(arylene sulfide) polymer particles which have been washed with a liquid (e.g., water) and filtered to remove the alkali metal halide by-product (and/or other liquid soluble impurities). The poly(arylene sulfide) polymer particles which can be treated can either be liquid wet or dry; alternatively, liquid wet; or alternatively, dry.

Acid treatment can comprise a) contacting the poly(arylene sulfide) with water to form a poly(arylene sulfide) slurry, b) contacting the poly(arylene sulfide) slurry with an acidic compound to form an acidic mixture, c) heating the acidic mixture in the substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the poly(arylene sulfide) with an aqueous solution comprising an acidic compound to form an acidic mixture, b) heating the acidic mixture in the substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,644, which is incorporated by reference herein in its entirety.

Generally, the metal cation treatment can comprise a) contacting the poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in the substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in the substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppm to about 10,000 ppm, from about 75 ppm to about 7,500 ppm, or from about 100 ppm to about 5,000 ppm. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the acid treatment process are provided in EP patent publication 0103279 A1, which is incorporated by reference herein in its entirety.

Once the poly(arylene sulfide) has been acid treated and/or metal cation treated, the acid treated and/or metal cation treated poly(arylene sulfide) can be separated from a treatment solution via a filtration step. Generally, the process/steps for recovering the acid treated and/or metal cation treated poly(arylene sulfide) can be the same steps as those for separating and/or isolating the poly(arylene sulfide) polymer particles from the reaction mixture.

Once the poly(arylene sulfide) polymer particles have been recovered (either in raw, acid treated, metal cation treated, or acid treated and metal cation treated form), the poly(arylene sulfide) can be dried and optionally cured. In an embodiment, a process for producing a poly(arylene sulfide) polymer can comprise a step of drying at least a portion of the poly(arylene sulfide) polymer particles to obtain a dried poly(arylene sulfide) polymer.

Generally, the poly(arylene sulfide) drying process can be performed at any temperature which can substantially dry the poly(arylene sulfide), to yield a dried poly(arylene sulfide) polymer. Preferably, a drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) polymer particles to an elevated temperature, below its melting point, in the presence of gaseous oxidizing atmosphere, thereby forming cured poly(arylene sulfide) polymer (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titanium dioxide, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyalphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, a process for producing a poly(phenylene sulfide) polymer can comprise (a) reacting a sulfur source and a halogenated aromatic compound having two halogens (e.g., dihaloaromatic compound) in the presence of N-methyl-2-pyrrolidone to form a reaction mixture; (b) quenching the reaction mixture by adding a quench liquid thereto to form a quenched mixture, wherein the quench liquid comprises a particle size modifying additive selected from the group consisting of sodium acetate, sodium benzoate, lithium acetate, lithium benzoate, lithium formate, sodium formate, and combinations thereof; and (c) cooling the quenched mixture to yield poly(phenylene sulfide) polymer particles. In such embodiment, the poly(phenylene sulfide) polymer is characterized by a weight average molecular weight of less than about 40,000 g/mole, and the poly(phenylene sulfide) polymer particles are characterized by a particle size of greater than about 80 microns.

In an embodiment, a process for producing a poly(phenylene sulfide) polymer can comprise (a) reacting a sulfur source and p-dichlorobenzene in the presence of N-methyl-2-pyrrolidone to form a reaction mixture; (b) quenching the reaction mixture by adding a quench liquid thereto to form a quenched mixture, wherein the quench liquid comprises a particle size modifying additive; and (c) cooling the quenched mixture to yield poly(phenylene sulfide) polymer particles, wherein the poly(phenylene sulfide) polymer is characterized by a weight average molecular weight of less than about 40,000 g/mole, and a particle size of greater than about 80 microns. In such embodiment, the particle size modifying additive can comprise sodium acetate.

In an embodiment, a process for producing a poly(phenylene sulfide) polymer can comprise (a) polymerizing reactants in a reaction vessel, wherein at least a portion of the reactants undergo a polymerization reaction; (b) quenching the polymerization reaction by adding a quench liquid to the reaction vessel, wherein the quench liquid comprises a particle size modifying additive; and (c) cooling down the reaction vessel, thereby forming poly(phenylene sulfide) polymer particles, wherein the poly(phenylene sulfide) polymer is characterized by a weight average molecular weight of less than about 40,000 g/mole, and wherein the poly(phenylene sulfide) polymer particles are characterized by a particle size of greater than about 80 microns. In such embodiment, the particle size modifying additive can comprise sodium acetate.

In an embodiment, a process for producing a poly(phenylene sulfide) polymer can comprise (a) polymerizing reactants in a reaction vessel, wherein at least a portion of the reactants undergo a polymerization reaction; (b) quenching the polymerization reaction by adding a quench liquid to the reaction vessel, wherein the quench liquid comprises a particle size modifying additive selected from the group consisting of sodium acetate, sodium benzoate, lithium acetate, lithium benzoate, sodium formate, lithium formate, and combinations thereof; and (c) cooling down the reaction vessel, thereby forming poly(phenylene sulfide) polymer particles, wherein the poly(phenylene sulfide) polymer is characterized by a weight average molecular weight of less than about 40,000 g/mole, and wherein the poly(phenylene sulfide) polymer particles are characterized by a particle size of greater than about 80 microns.

In an embodiment, a process for producing a poly(phenylene sulfide) polymer via a quench process can comprise adding a compound selected from the group consisting of sodium acetate, sodium benzoate, lithium acetate, lithium benzoate, sodium formate, lithium formate, and combinations thereof upon substantial completion of a reaction cycle of the quench process and prior to a cooling and particle formation cycle of the quench process.

In an embodiment, a process for producing a poly(phenylene sulfide) polymer can comprise a quench process having a reaction cycle, a quench cycle, and a cooling/particle formation cycle, wherein the process comprises adding a compound selected from the group consisting of sodium acetate, sodium benzoate, lithium acetate, lithium benzoate, sodium formate, lithium formate, and combinations thereof during the quench cycle.

In an embodiment, the process for producing a poly(arylene sulfide) polymer as disclosed herein advantageously displays an increased yield of the poly(arylene sulfide) polymer, when compared to an otherwise similar process lacking a step of quenching the reaction mixture (e.g., quenching the polymerization reaction) by adding a quench liquid to the reaction mixture (e.g., to the reaction vessel), wherein the quench liquid comprises a particle size modifying additive. The use of a particle size modifying additive as part of the quench liquid allows for the formation of larger size poly(arylene sulfide) polymer particles, thereby leading to the increased yield of the poly(arylene sulfide) polymer. As will be appreciated by one of skill in the art, and with the help of this disclosure, it is easier to recover larger polymer particles (e.g., poly(arylene sulfide) polymer particles) as they can be retained on screens with larger size apertures.

In an embodiment, the use of a particle size modifying additive as disclosed herein can advantageously lead to a poly(arylene sulfide) polymer characterized by both a low molecular weight (e.g., a weight average molecular weight of less than about 40,000 g/mole) and an increased particle size (e.g., greater than about 80 microns).

In an embodiment, the use of a particle size modifying additive as disclosed herein can advantageously lead to a decrease in reaction pressure (e.g., pressure in the reaction vessel) upon adding a quench liquid comprising the particle size modifying additive to the reaction mixture (e.g., to the reaction vessel), when compared to adding an otherwise similar quench liquid lacking the particle size modifying additive to the reaction mixture (e.g., to the reaction vessel). Additional advantages of the process for the production of a poly(arylene sulfide) polymer as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

The effect of quenching on polymer product was studied. More specifically, the effect of the type of quenching liquid on PPS yield and properties (e.g., melt flow) was investigated. Three different PPS samples were prepared. All samples were prepared using similar polymerization conditions, and reactants were scaled in each case to a theoretical 90 lbs batch size. General reaction conditions (e.g., reaction cycle, stoichiometry, etc.) were previously described herein.

For example, PPS can be prepared according to the following recipe describing an example of a reaction cycle. To a 1-liter titanium reactor was added 0.666 mole of NaSH (62.50 grams), 0.680 mole of NaOH (27.61 grams), and 1.665 moles of N-methyl-2-pyrrolidone (165.05 grams). The reactor was closed and the reactor stirrer operated at 175 revolutions per minute. The reactor was purged of air by charging the reactor with nitrogen to 50 psig and then depressurizing the reactor five consecutive times, and then charging the reactor with nitrogen to 200 psig and then depressurizing the reactor five consecutive times. Water was then removed (also referred to as dehydration) from the reactor by heating the reactor to approximately 140° C. The dehydration line was then opened, a nitrogen flow rate of 32 cc/minute was introduced into the reactor, and the reactor was heated to approximately 200° C. over a period of 95 minutes. During this time 25 mL of liquid was collected. Gas chromatography of the collected liquid indicated that the collected liquid contained 96 weight % water and 4.0 weight % N-methyl-2-pyrrolidone. Upon completion of the dehydration, the dehydration line was closed, the reactor was charged to 50 psig with nitrogen, and the nitrogen flow was discontinued. The reactor was then heated to 250° C. To a 0.3 liter charging vessel was added 0.666 mole of para-dichlorobenzene (98.0 grams) and 0.25 mole of N-methyl-2-pyrrolidone (25.0 grams). The charging vessel was then purged with nitrogen, closed, and placed in a heated bath (at approximately 100° C.) until it was to be charged to the reactor. When the reactor reached 250° C., the contents of the charging vessel were then pressured (nitrogen pressure) into the reactor. The charging vessel was rinsed with 0.5 mole of N-methyl-2-pyrrolidone (49.56 grams) and the rinse was pressured (nitrogen pressure) into the reactor. Once the contents of the charging vessel were charged to the reactor, the reactor temperature was increased to 250° C. and was maintained at 250° C. for approximately four hours.

Prior to quenching the reaction mixture, the conditions, including excess reagents, were determined to be comparable between the three sample preparations. All polymerization conditions were similar, and the samples (e.g., PPS sample preparation) differed in the quenching cycle. The three samples were quenched using different quench liquids (e.g., different quenching additives) as shown in Table 1 and then each sample was cooled and transferred from the reactor for further analysis.

TABLE 1

| | | PPS | |
|---|---|---|---|
| | | recovered | Melt flow |
| | Quench Liquid | [lbs] | [g/10 min.] |
| Sample #1 | 2.0 gallons DI water | 37 | 606 |
| Sample #2 | 2.8 gallons NaOAc solution | 54 | 820 |
| Sample #3 | 2.0 gallons NMP | 0 | N/A |

Sample #1 was quenched with 2 gallons (7.6 L) of de-ionized (DI) water. Sample #2 was quenched with 2.8 gallons (10.6 L) of an aqueous solution of NaOAc in DI water, wherein the entire amount of aqueous solution of NaOAc contained 4 lbs (1.8 kg) of NaOAc by weight. Sample #3 was quenched with 2 gallons (7.6 L) of NMP. For each sample, the resulting polymer was collected by washing the reactor contents. The sequence for collection included washing with 50 gallons (189.3 L) of 170° F. NMP using an 80 mesh rotary shaker screen to collect the PPS polymer. The polymer wet cake was then washed three times on a belt filter with DI water. The first 2×115 gallons (435.3 L) washes were done at 140° F., and the second wash included 250 mL of glacial acetic acid. The third 115 gallons (435.3 L) water wash was completed at ambient temperature.

As it can be seen from the results in Table 1, when NMP was used as a quench liquid (Sample #3) no PPS was recovered, indicating the size of the PPS particles was smaller than 80 mesh. When DI water was used as a quench liquid (Sample #1), 37 lbs (16.8 kg) of PPS were recovered. The addition of NaOAc to the quench liquid (Sample #2) resulted in recovery of 54 lbs (24.5 kg) of PPS, an increase of about 46% in the PPS yield, indicating that NaOAc functioned as a particle size modifying additive, e.g., NaOAc contributed to increasing the size of PPS particles, thereby increasing the PPS yield.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### Additional Disclosure

A first embodiment, which is a process comprising:

(a) reacting a sulfur source and a dihaloaromatic compound in the presence of a polar organic compound to form a reaction mixture;

(b) quenching the reaction mixture by adding a quench liquid thereto to form a quenched mixture, wherein the quench liquid comprises a particle size modifying additive; and

(c) cooling the quenched mixture to yield poly(arylene sulfide) polymer particles.

A second embodiment, which is the process of the first embodiment, wherein the particle size modifying additive comprises an alkali metal carboxylate.

A third embodiment, which is the process of the second embodiment, wherein the alkali metal carboxylate has a general formula R′CO₂M, wherein R′ is a C₁ to C₂₀ hydrocarbyl group and M is an alkali metal.

A fourth embodiment, which is the process of the third embodiment, wherein R′ comprises an alkyl group, a cycloalkyl group, an aryl group, or an aralkyl group.

A fifth embodiment, which is the process of any of the third through the fourth embodiments, wherein the alkali metal comprises lithium, sodium, potassium, rubidium, or cesium.

A sixth embodiment, which is the process of any of the second through the fifth embodiments, wherein the alkali metal carboxylate comprises sodium acetate, sodium benzoate, lithium acetate, lithium benzoate, lithium formate, sodium formate, or combinations thereof.

A seventh embodiment, which is the process of any of the first through the sixth embodiments, wherein the particle size modifying additive is added to the reaction mixture in an amount of from about 0.01 mole to about 1.0 mole of particle size modifying additive per mole of sulfur.

An eighth embodiment, which is the process of any of the first through the seventh embodiments, wherein the particle size modifying additive is added to the reaction mixture in an amount effective to increase a yield of the poly(arylene sulfide) polymer by greater than about 5 wt. %, when compared to adding an otherwise similar quench liquid lacking the particle size modifying additive.

A ninth embodiment, which is the process of any of the first through the eighth embodiments, wherein the particle size modifying additive is added to the reaction mixture in an amount effective to increase a particle size of the poly(arylene sulfide) polymer particles by greater than about 10%, when compared to adding an otherwise similar quench liquid lacking the particle size modifying additive.

A tenth embodiment, which is the process of the first through ninth embodiments, wherein the quench liquid comprises a polar organic compound and/or water.

An eleventh embodiment, which is the process of any of the first through the tenth embodiments, wherein the particle size modifying additive is present in the quench liquid in an amount of from about 1 wt. % to about 80 wt. %, based on the total weight of the quench liquid.

A twelfth embodiment, which is the process of any of the first through the eleventh embodiments, wherein adding a quench liquid comprising the particle size modifying additive decreases a reaction pressure by from about 1% to about 30%, when compared to adding an otherwise similar quench liquid lacking the particle size modifying additive.

A thirteenth embodiment, which is the process of any of the first through the twelfth embodiments, wherein the reaction mixture further comprises a molecular weight modifying agent.

A fourteenth embodiment, which is the process of the thirteenth embodiment, wherein the molecular weight modifying agent is present in the reaction mixture in an amount of from about 0 mole to about 1.0 mole of molecular weight modifying agent per mole of sulfur.

A fifteenth embodiment, which is the process of any of the thirteenth through the fourteenth embodiments, wherein the amount of the molecular weight modifying agent added in (a) and the amount of particle size modifying additive added in (b) total from about 0.01 mole to about 1.0 mole of molecular weight modifying agent and particle size modifying additive per mole of sulfur.

A sixteenth embodiment, which is the process of any of thirteenth through the fifteenth embodiments, wherein the molecular weight modifying agent and the particle size modifying additive are added in a mole ratio of from about 0.00:0.01 to about 1.0:0.01 of molecular weight modifying agent to particle size modifying additive.

A seventeenth embodiment, which is the process of any of the thirteenth through the sixteenth embodiments, wherein the molecular weight modifying agent and the particle size modifying additive are the same.

An eighteenth embodiment, which is the process of any of the thirteenth through the seventeenth embodiments, wherein the molecular weight modifying agent and the particle size modifying additive are selected from the group consisting of sodium acetate, sodium benzoate, lithium acetate, lithium benzoate, lithium formate, sodium formate, and combinations thereof.

A nineteenth embodiment, which is the process of any of the thirteenth through the sixteenth and the eighteenth embodiments, wherein the molecular weight modifying agent and the particle size modifying additive are different.

A twentieth embodiment, which is the process of any of the first through the nineteenth embodiments, wherein the poly(arylene sulfide) polymer is characterized by a weight average molecular weight of less than about 40,000 g/mole.

A twenty-first embodiment, which is the process of any of the first through the twentieth embodiments, wherein the particle size modifying additive does not modify the weight average molecular weight of the poly(arylene sulfide) polymer.

A twenty-second embodiment, which is the process of any of the first through the twenty-first embodiments, wherein the poly(arylene sulfide) polymer particles are characterized by a particle size of greater than about 80 microns.

A twenty-third embodiment, which is the process of any of the first through the twenty-second embodiments, wherein the poly(arylene sulfide) polymer particles have a particle size distribution wherein Dw90 is equal to or greater than about 100 microns.

A twenty-fourth embodiment, which is the process of any of the first through the twenty-third embodiments, wherein equal to or greater than about 95 wt. % of the poly(arylene sulfide) polymer particles are retained on a 100 mesh sieve.

A twenty-fifth embodiment, which is the process of any of the first through the twenty-fourth embodiments, wherein the poly(arylene sulfide) is a poly(phenylene sulfide).

A twenty-sixth embodiment, which is a process for producing a poly(phenylene sulfide) polymer comprising:

(a) reacting a sulfur source and a dihaloaromatic compound in the presence of N-methyl-2-pyrrolidone to form a reaction mixture;

(b) quenching the reaction mixture by adding a quench liquid thereto to form a quenched mixture, wherein the quench liquid comprises a particle size modifying additive selected from the group consisting of sodium acetate, sodium benzoate, lithium acetate, lithium benzoate, lithium formate, sodium formate, and combinations thereof; and

(c) cooling the quenched mixture to yield poly(phenylene sulfide) polymer particles.

A twenty-seventh embodiment, which is the process of the twenty-sixth embodiment, wherein the poly(phenylene sulfide) polymer is characterized by a weight average molecular weight of less than about 40,000 g/mole and a particle size of greater than about 80 microns.

A twenty-eighth embodiment, which is the process of the twenty-sixth through the twenty-seventh embodiments, wherein the particle size modifying additive does not modify the weight average molecular weight of the poly(phenylene sulfide) polymer.

A twenty-ninth embodiment, which is a process for producing a poly(phenylene sulfide) polymer comprising:

(a) reacting a sulfur source and a dihaloaromatic compound in the presence of N-methyl-2-pyrrolidone to form a reaction mixture;

(b) quenching the reaction mixture by adding a quench liquid thereto to form a quenched mixture, wherein the quench liquid comprises a particle size modifying additive; and

(c) cooling the quenched mixture to yield poly(phenylene sulfide) polymer particles,

wherein the poly(phenylene sulfide) polymer is characterized by a weight average molecular weight of less than about 40,000 g/mole, and a particle size of greater than about 80 microns.

A thirtieth embodiment, which is a process for producing a poly(phenylene sulfide) polymer via quench process comprising adding a compound selected from the group consisting of sodium acetate, sodium benzoate, lithium acetate, lithium benzoate, sodium formate, lithium formate, and combinations thereof upon substantial completion of a reaction cycle of the quench process and prior to a cooling and particle formation cycle of the quench process.

A thirty-first embodiment, which is a process for producing a poly(phenylene sulfide) polymer via process having a reaction cycle, a quench cycle, and a cooling/particle formation cycle, wherein the process comprises adding a compound selected from the group consisting of sodium acetate, sodium benzoate, lithium acetate, lithium benzoate, sodium formate, lithium formate, and combinations thereof during the quench cycle.

A thirty-second embodiment, which is the process of the thirtieth through the thirty-first embodiments wherein the compound is added via quench liquid comprising water, N-methyl-2-pyrrolidone, or both.

A thirty-third embodiment, which is a process for producing a poly(phenylene sulfide) polymer comprising:

(a) polymerizing reactants in a reaction vessel, wherein at least a portion of the reactants undergo a polymerization reaction;

(b) quenching the polymerization reaction by adding a quench liquid to the reaction vessel, wherein the quench liquid comprises a particle size modifying additive; and

(c) cooling down the reaction vessel, thereby forming raw poly(phenylene sulfide) polymer particles.

A thirty-fourth embodiment, which is a process for producing a poly(phenylene sulfide) polymer comprising:

(a) polymerizing reactants in a reaction vessel, wherein at least a portion of the reactants undergo a polymerization reaction;

(b) quenching the polymerization reaction by adding a quench liquid to the reaction vessel, wherein the quench liquid comprises a particle size modifying additive selected from the group consisting of sodium acetate, sodium benzoate, lithium acetate, lithium benzoate, sodium formate, lithium formate, and combinations thereof; and

(c) cooling down the reaction vessel, thereby forming raw poly(phenylene sulfide) polymer particles,

wherein the poly(phenylene sulfide) polymer is characterized by a weight average molecular weight of less than about 40,000 g/mole, and wherein the raw poly(phenylene sulfide) polymer particles are characterized by a particle size of greater than about 80 microns.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. A process comprising:
(a) reacting a sulfur source and a dihaloaromatic compound in the presence of a polar organic compound to form a reaction mixture;
(b) quenching the reaction mixture by adding a quench liquid thereto to form a quenched mixture, wherein the quench liquid comprises from about 1 wt. % to about 80 wt. % of a particle size modifying additive, based on a total weight of the quench liquid; and
(c) cooling the quenched mixture to yield poly(arylene sulfide) polymer particles.

2. The process of claim 1, wherein the particle size modifying additive comprises an alkali metal carboxylate.

3. The process of claim 2, wherein the alkali metal carboxylate has a general formula R′CO₂M, wherein R′ is a C₁ to C₂₀ hydrocarbyl group and M is an alkali metal.

4. The process of claim 3, wherein R′ comprises an alkyl group, a cycloalkyl group, an aryl group, or an aralkyl group.

5. The process of claim 3, wherein the alkali metal comprises lithium, sodium, potassium, rubidium, or cesium.

6. The process of claim 2, wherein the alkali metal carboxylate comprises sodium acetate, sodium benzoate, lithium acetate, lithium benzoate, lithium formate, sodium formate, or combinations thereof.

7. The process of claim 1, wherein the particle size modifying additive is added to the reaction mixture in an amount of from about 0.01 mole to about 1.0 mole of particle size modifying additive per mole of sulfur.

8. The process of claim 1, wherein the particle size modifying additive is added to the reaction mixture in an amount effective to increase a yield of the poly(arylene sulfide) polymer by greater than about 5 wt. %, when compared to adding an otherwise similar quench liquid lacking the particle size modifying additive.

9. The process of claim 1, wherein the particle size modifying additive is added to the reaction mixture in an amount effective to increase a particle size of the poly(arylene sulfide) polymer particles by greater than about 10%, when compared to adding an otherwise similar quench liquid lacking the particle size modifying additive.

10. The process of claim 1, wherein the quench liquid comprises a polar organic compound and/or water.

11. (canceled)

12. The process of claim 1, wherein adding a quench liquid comprising the particle size modifying additive decreases a reaction pressure by from about 1% to about 30%, when compared to adding an otherwise similar quench liquid lacking the particle size modifying additive.

13. The process of claim 1, wherein the reaction mixture further comprises a molecular weight modifying agent.

14. The process of claim 13, wherein the molecular weight modifying agent is present in the reaction mixture in an amount of from about 0 mole to about 1.0 mole of molecular weight modifying agent per mole of sulfur.

15. The process of claim 13, wherein the amount of the molecular weight modifying agent added in (a) and the amount of particle size modifying additive added in (b) total from about 0.01 mole to about 1.0 mole of molecular weight modifying agent and particle size modifying additive per mole of sulfur.

16. The process of claim 15, wherein the molecular weight modifying agent and the particle size modifying additive are added in a mole ratio of from about 0.00:0.01 to about 1.0:0.01 of molecular weight modifying agent to particle size modifying additive.

17. The process of claim 13, wherein the molecular weight modifying agent and the particle size modifying additive are selected from the group consisting of sodium acetate, sodium benzoate, lithium acetate, lithium benzoate, lithium formate, sodium formate, and combinations thereof.

18. The process of claim 1, wherein the poly(arylene sulfide) polymer is characterized by a weight average molecular weight of less than about 40,000 g/mole.

19. The process of claim 1, wherein the particle size modifying additive does not modify the weight average molecular weight of the poly(arylene sulfide) polymer.

20. The process of claim 1, wherein the poly(arylene sulfide) polymer particles are characterized by a particle size of greater than about 80 microns, wherein the poly(arylene sulfide) polymer particles have a particle size distribution wherein Dw90 is equal to or greater than about 100 microns, wherein equal to or greater than about 95 wt. % of the poly(arylene sulfide) polymer particles are retained on a 100 mesh sieve, or combinations thereof.

21. A process for producing a poly(phenylene sulfide) polymer comprising:
(a) reacting a sulfur source and a dihaloaromatic compound in the presence of N-methyl-2-pyrrolidone to form a reaction mixture;
(b) quenching the reaction mixture by adding a quench liquid thereto to form a quenched mixture, wherein the quench liquid comprises from about 1 wt. % to about 80 wt. % of a particle size modifying additive, based on a total weight of the quench liquid, and the particle size modifying additive is selected from the group consisting of sodium acetate, sodium benzoate, lithium acetate, lithium benzoate, lithium formate, sodium formate, and combinations thereof; and
(c) cooling the quenched mixture to yield poly(phenylene sulfide) polymer particles.

22. A process for producing a poly(phenylene sulfide) polymer via a process having a reaction cycle, a quench cycle, and a cooling/particle formation cycle, wherein the process comprises adding a compound selected from the group consisting of sodium acetate, sodium benzoate, lithium acetate, lithium benzoate, sodium formate, lithium formate, and combinations thereof during the quench cycle, and wherein the process comprises a quench liquid in which the quench liquid comprises from about 1 wt. % to about 80 wt. % of a particle size modifying additive, based on a total weight of the quench liquid.
